(19) United States
(12) Patent Application Publication
(10) Pub. No.: US 2026/0264448 A1
(43) Pub. Date: Sep. 10, 2026

(54) ROLLER-SUPPORTED MULTI-PIECE OMNIDIRECTIONAL WHEEL

(71) Applicant: Guangdong Prestige Technology Company Limited, Dongguan, Guangdong (CN)

(72) Inventor: Zhao Zhang, Dongguan, Guangdong (CN)

(21) Appl. No.: 19/167,861

(22) PCT Filed: May 24, 2024
(86) PCT No.: PCT/CN2024/095108

§ 371 Date: Sep. 23, 2025

(30) Foreign Application Priority Data
Apr. 3, 2023 (CN) 202320713366.8

(51) Int. Cl. B60B 19/00; B60B 19/12; B60B 25/00

(52) U.S. Cl. CPC B60B 19/003; B60B 19/12; B60B 25/002

(57) ABSTRACT

A roller-supported multi-piece omnidirectional wheel (100), comprises a rim (1), a support ring (2), a plurality of wheel pieces (3), and a plurality of rollers (4). The wheel pieces (3) are rotatably sleeved on the support ring (2), and the wheel pieces (3) are circumferentially arranged on the periphery of the rim (1) around the central axis of the rim (1); the support ring (2) and the rim (1) are concentrically arranged; the rollers (4) are pivotally connected to two sides of the interior of the rim (1), and the rollers (4) are in rolling contact with the periphery of the wheel pieces (3). The roller-supported multi-piece omnidirectional wheel (100) has the advantages of flexible steering, simple structure and convenient assembly.

### FIELD OF THE INVENTION

The present invention relates to an omnidirectional wheel, and more particularly to a roller-supported multi-piece omnidirectional wheel.

### BACKGROUND OF THE INVENTION

Existing omnidirectional wheels generally utilize multiple roller sets assembled on a rim to achieve rolling in both forward/backward and left/right directions. A roller set includes a bracket, a large roller, and a pair of small rollers. The large roller is pivotally connected to the bracket, and the small rollers are located on either side of the large roller and are also pivotally connected to the bracket. Obviously, this omnidirectional wheel includes two different types of rollers, which requires the bracket to be manufactured specially to fit with the different rollers. This not only complicates the structure of the omnidirectional wheel but also makes installation cumbersome and assembly inconvenient.

### SUMMARY OF THE INVENTION

The objective of the present invention is to provide a roller-supported multi-piece omnidirectional wheel that offers flexible steering, a simple structure, and convenient assembly.

In order to achieve the above objective, the present invention provides a roller-supported multi-piece omnidirectional wheel including a rim, a support ring, a plurality of wheel pieces, and a plurality of rollers. The wheel pieces are rotatably sleeved on the support ring and arranged circumferentially around an outer periphery of the rim about a central axis of the rim. The support ring is concentrically arranged with the rim. The rollers are pivotally connected to both inner sides of the rim and in rolling contact with an outer periphery of the wheel pieces.

Compared to the prior art, in the present invention, the wheel pieces are sleeved on onto the support ring and also arranged circumferentially around the outer periphery of the rim, with the support ring being concentric with the rim; furthermore, the rollers are pivotally connected to both inner sides of the rim, and in rolling contact with the wheel pieces. On one hand, the wheel pieces and the support ring can be stably supported on the outer periphery of the rim, allowing these wheel pieces to collectively form an integrated wheel which achieves rolling forward and backward around the central axis of the rim. On the other hand, it allows each wheel piece to stably and smoothly rotate around its own central axis, thereby enabling the omnidirectional wheel to achieve rolling in left and right directions. By this token, the omnidirectional wheel of the present invention can perform multi-directional rolling with flexible steering. Moreover, the omnidirectional wheel has fewer component combinations to bring a simple and compact structure, and the assembly is convenient.

Preferably, central axes of both the wheel pieces and the rollers are perpendicular to the central axis of the rim.

Preferably, the rollers are arranged circumferentially about the central axis of the rim.

Preferably, an outer side of the rim is circumferentially recessed with a mounting groove, and the rollers and the wheel pieces are arranged within the mounting groove. The mounting groove can accommodate the support ring and a portion of the wheel pieces, thereby not only hiding another portion of the wheel pieces to improve the concise appearance of the omnidirectional wheel but also making the overall volume of the omnidirectional wheel smaller to obtain a compact structure.

Specifically, the roller-supported multi-piece omnidirectional wheel further includes roller supports which are circumferentially mounted within the mounting groove about the central axis of the rim. By providing the roller supports, the assembly of the rollers becomes easier and more convenient.

Preferably, the roller-supported multi-piece omnidirectional wheel further includes positioning brackets arranged between two adjacent wheel pieces to axially position the wheel pieces. In such a way, the wheel pieces are prevented from moving along the direction of the central axis of the support ring, thereby improving the stability and the operation safety.

Specifically, the roller-supported multi-piece omnidirectional wheel further includes bearings sleeved between the support ring and the wheel pieces, and two adjacent positioning brackets are pressed against inner rings of the bearings. With the bearings, the wheel pieces can rotate more stably and smoothly.

Specifically, shaft sleeves are extended from opposite sides of the positioning brackets, and the shaft sleeves are pressed against the inner rings of the bearings.

Preferably, each wheel piece includes an inner wheel and an outer wheel sleeve, and the outer wheel sleeve is fixedly sleeved around an outer periphery of the inner wheel.

Specifically, an outer surface of the inner wheel is circumferentially provided with positioning ribs, and an inner wall of the outer wheel sleeve is circumferentially provided with engagement slots that engage with the positioning ribs. This allows the outer wheel sleeve and the inner wheel to be relatively fixed, thereby enhancing the stability of the connection.

Preferably, the rim includes a left rim and a right rim, which are fixedly connected coaxially. By configuring the rim as a combination of a left rim and a right rim, processing of the rim is facilitated, and the installations of the wheel pieces and rollers are easier, thereby improving the convenience of assembly.

### BRIEF DESCRIPTION OF THE DRAWINGS

FIG. 1 is a perspective view of the roller-supported multi-piece omnidirectional wheel according to the present invention.

FIG. 2 is an exploded view of the roller-supported multi-piece omnidirectional wheel according to the present invention.

FIG. 3 is a structural view of the roller-supported multi-piece omnidirectional wheel of the present invention with one side according to the rim removed.

FIG. 4 is a radial cross-sectional view of the roller-supported multi-piece omnidirectional wheel according to the present invention.

FIG. 5 is an enlarged view of portion A in FIG. 4.

FIG. 6 is an axial cross-sectional view of the roller-supported multi-piece omnidirectional wheel according to the present invention.

FIG. 7 is a perspective view of the positioning bracket of the roller-supported multi-piece omnidirectional wheel according to the present invention.

### DETAILED DESCRIPTION OF ILLUSTRATED EMBODIMENTS

To elaborate the technical content, structural features, and achieved effects of the present invention, the following description is provided in conjunction with the embodiments and the drawings for a detailed explanation.

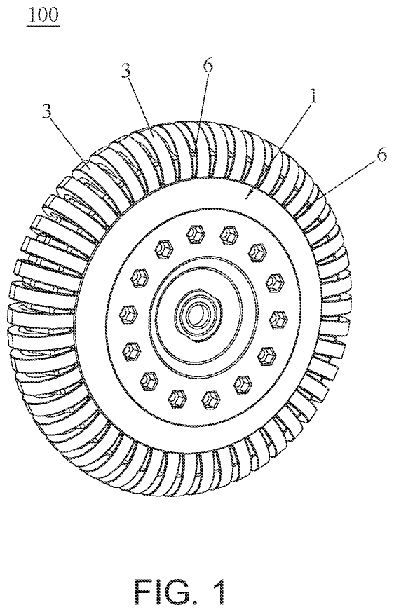

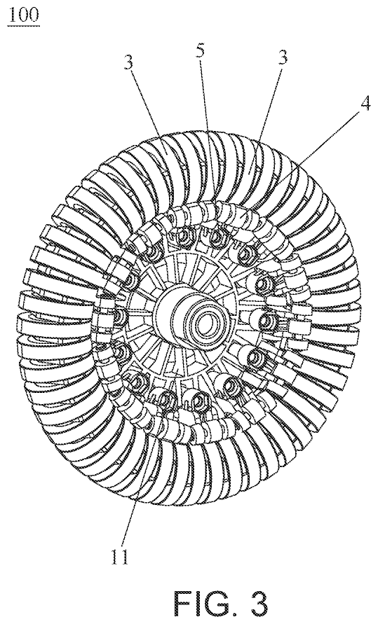

As shown in FIGS. 1 to 5, the roller-supported multi-piece omnidirectional wheel 100 of the present invention includes a rim 1, a support ring 2, a plurality of wheel pieces 3, and a plurality of rollers 4. The cross-section of the wheel pieces 3 is annular. The wheel pieces 3 are rotatably sleeved on the support ring 2 and arranged circumferentially around an outer periphery of the rim 1 about a central axis of the rim 1. The support ring 2 is concentrically arranged with the rim 1. The rollers 4 are pivotally connected to both inner sides of the rim 1 and in rolling contact with an outer periphery of the wheel pieces 3. The rollers 4 are arranged circumferentially about the central axis of the rim 1. The central axes of both the wheel pieces 3 and the rollers 4 are perpendicular to the central axis of the rim 1.

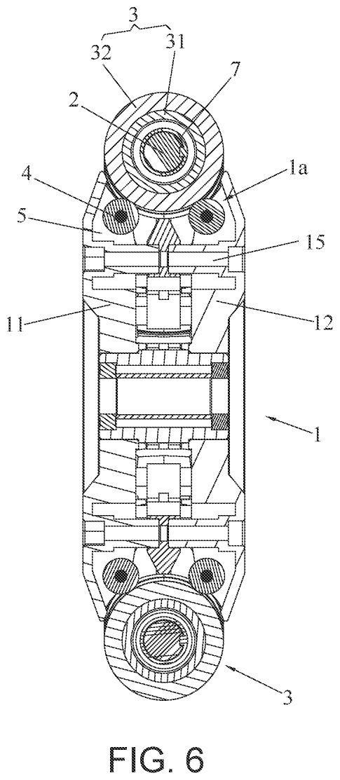

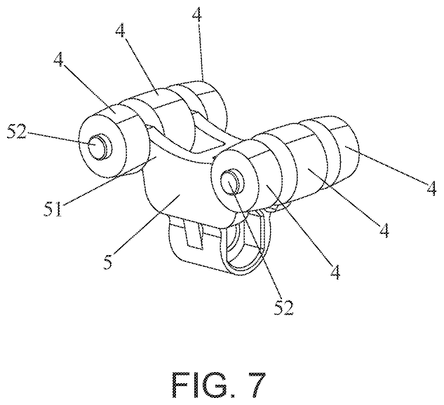

Referring to FIGS. 6 and 7, the outer side of the rim 1 is circumferentially recessed with a mounting groove la. The rollers 4 and the wheel pieces 3 are arranged within the mounting groove la. The mounting groove la can accommodate the support ring 2 and a portion of the wheel pieces 3, thereby not only hiding another portion of the wheel pieces 3 to improve the concise appearance of the omnidirectional wheel but also making the overall volume of the omnidirectional wheel smaller to obtain a compact structure. Specifically, the roller-supported multi-piece omnidirectional wheel 100 further includes roller supports 5. The roller supports 5 are circumferentially installed within the mounting groove 1a around the central axis of the rim 1. By providing the roller supports 5, the assembly of the rollers 4 becomes easier and more convenient. The lower end of each roller support 5 is sleeved and fixed onto a fixed column within the rim 1. The upper end of the roller support 5 extends toward both sides of the mounting groove la of the wheel pieces 3 to form two branched portions 51. The branched portions 51 are provided with pivot shafts 52, and the rollers 4 are pivoted onto the pivot shafts 52. Furthermore, to adapt to the circular structure formed by the wheel pieces 3 and to enable the rollers 4 to be in rolling contact with the wheel pieces 3, the pivot shafts 52 can be configured as linear, and multiple rollers 4 can be pivoted on one pivot shaft 52. In this embodiment, three rollers 4 are pivoted on one pivot shaft 52, and the surfaces of the rollers 4 located on both sides are arc-shaped to adapt to the wheel pieces 3. Additionally, the pivot shafts 52 may be curved or bent, so that the surface of each roller 4 can fully contact the surface of the corresponding wheel piece 3, thereby making rolling more stable.

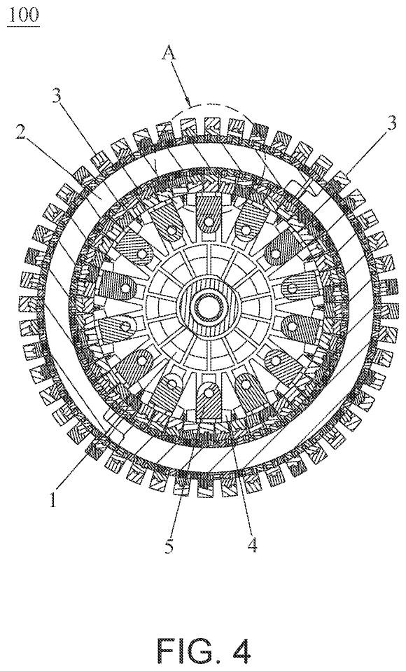

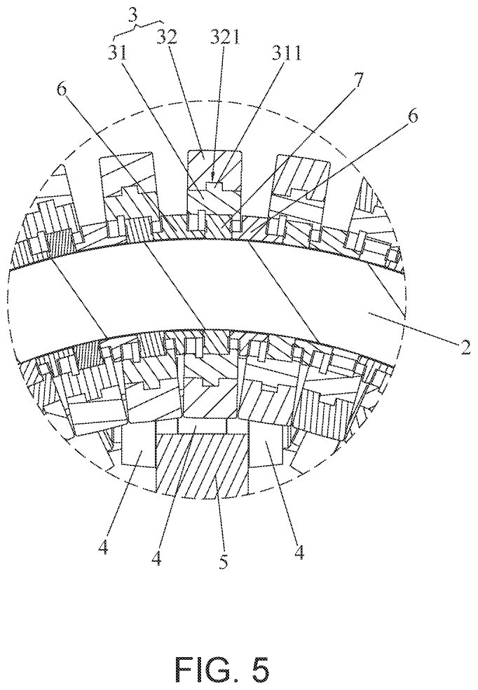

As shown in FIGS. 4 and 5, the roller-supported multi-piece omnidirectional wheel 100 further includes positioning brackets 6 and bearings 7. The positioning brackets 6 are arranged between two adjacent wheel pieces 3 to axially position the wheel pieces 3. In such a way, the wheel pieces 3 is prevented from moving along the direction of the central axis of the support ring 2, thereby improving the stability of the omnidirectional wheel and the safety of its operation. The bearings 7 are sleeved between the support ring 2 and the wheel pieces 3, and two adjacent positioning brackets 6 are pressed against inner rings of the bearings 7. With the configuration of the bearings 7, the wheel pieces 3 can rotate more stably and smoothly. More specifically, shaft sleeves are extended from opposite sides of each of the positioning brackets 61, and the shaft sleeves are pressed against the inner rings of the bearings 7 on the same side.

Referring again to FIG. 5, the wheel piece 3 includes an inner wheel 31 and an outer wheel sleeve 32. The outer wheel sleeve 32 is sleeved and fixed onto the outer periphery of the inner wheel 31. The outer surface of the inner wheel 31 is circumferentially provided with positioning ribs 311. The inner wall of the outer wheel sleeve 32 is circumferentially provided with engagement slots 321 which engage with the positioning ribs 311. In such a way, the outer wheel sleeve 32 and the inner wheel 31 is relatively fixed, enhancing the stability of the connection. The outer wheel sleeve 32 can be made of a relatively soft and wear-resistant material, such as rubber material. The inner wheel 31 can be made of a material with higher hardness, such as aluminum alloy material.

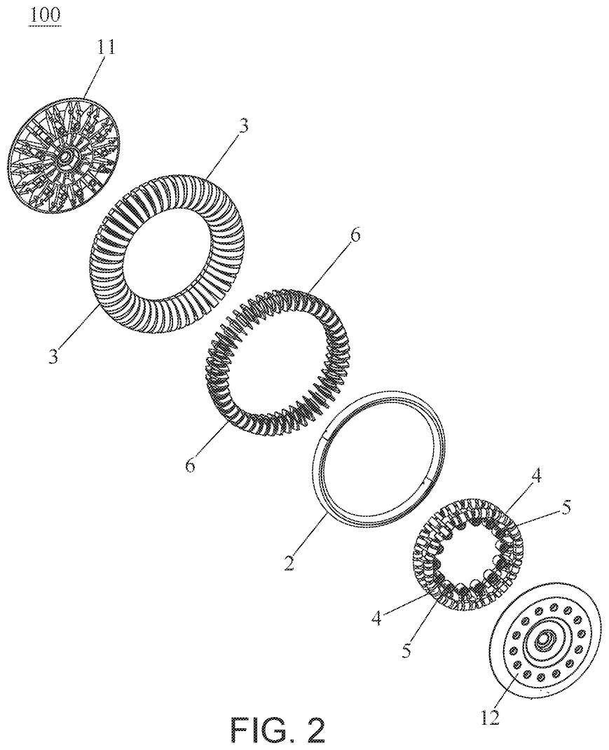

Also as shown in FIGS. 2 and 6, the rim 1 includes a left rim 11 and a right rim 12. The left rim 11 and the right rim 12 are fixedly connected coaxially by bolts. By configuring the rim 1 as a combination of a left rim 11 and a right rim 12, processing of the rim 1 is facilitated, and the installations of the wheel pieces 3 and rollers 4 are easier, thereby improving the convenience of assembly.

In this embodiment, the number of the positioning brackets 6, the bearings 7, and the wheel pieces 3 is 48 each. The central angle between two adjacent wheel pieces 3 or two adjacent positioning brackets 6 is 7.5 degrees. Of course, the number of the wheel pieces 3 or the positioning brackets 6 can also be fewer or greater. A person skilled in the art can calculate the central angle between two adjacent wheel pieces 3 based on the number of wheel pieces 3 or positioning brackets 6 and the radius of the omnidirectional wheel, and thereby calculate the length of the two shaft sleeves of the positioning bracket 6. This will not be explained in detail here.

Compared to the prior art, in the present invention, the wheel pieces 3 are sleeved on onto the support ring 2 and also arranged circumferentially around the outer periphery of the rim 1, with the support ring 2 being concentric with the rim 1; furthermore, the rollers 4 are pivotally connected to both inner sides of the rim 1, and in rolling contact with the wheel pieces 3. On one hand, the wheel pieces 3 and the support ring 2 can be stably supported on the outer periphery of the rim 1, allowing these wheel pieces 3 to collectively form an integrated wheel which achieves rolling forward and backward around the central axis of the rim 1. On the other hand, it allows each wheel piece 3 to stably and smoothly rotate around its own central axis, thereby enabling the omnidirectional wheel to achieve rolling in left and right directions. By this token, the omnidirectional wheel of the present invention can perform multi-directional rolling with flexible steering. Moreover, the omnidirectional wheel has fewer component combinations to bring a simple and compact structure, and the assembly is convenient.

The above descriptions are merely preferred embodiments of the present application and are not intended to limit the scope of the application. Any modifications, equivalent substitutions, or improvements made within the spirit and principles of the present application should be included within the protection scope of the present application.

1. A roller-supported multi-piece omnidirectional wheel, comprising a rim, a support ring, a plurality of wheel pieces, and a plurality of rollers; wherein the wheel pieces are rotatably sleeved on the support ring and arranged circumferentially around an outer periphery of the rim about a central axis of the rim; the support ring is concentrically arranged with the rim; an outer side of the rim is circumferentially recessed with a mounting groove, and the rollers and the wheel pieces are arranged within the mounting groove; the roller-supported multi-piece omnidirectional wheel further comprises roller supports which are circumferentially mounted within the mounting groove about the central axis of the rim; a lower end of each of the roller supports is sleeved and fixed onto a fixed column within the rim, and an upper end of each of the roller supports extends toward both sides of the mounting groove to form two branched portions; the branched portions are provided with pivot shafts, and the rollers are pivoted onto the pivot shafts; central axes of both the wheel pieces and the rollers are perpendicular to the central axis of the rim; and the rollers are in rolling contact with an outer periphery of the wheel pieces.

2. (canceled)

3. The roller-supported multi-piece omnidirectional wheel according to claim 1, wherein the rollers are arranged circumferentially about the central axis of the rim.

4. (canceled)

5. (canceled)

6. The roller-supported multi-piece omnidirectional wheel according to claim 1, further comprising positioning brackets arranged between two adjacent wheel pieces to axially position the wheel pieces.

7. The roller-supported multi-piece omnidirectional wheel according to claim 6, further comprising bearings sleeved between the support ring and the wheel pieces; wherein two adjacent positioning brackets are pressed against inner rings of the bearings.

8. The roller-supported multi-piece omnidirectional wheel according to claim 7, wherein shaft sleeves are extended from opposite sides of the positioning brackets, and the shaft sleeves are pressed against the inner rings of the bearings.

9. The roller-supported multi-piece omnidirectional wheel according to claim 1, wherein each wheel piece comprises an inner wheel and an outer wheel sleeve, and the outer wheel sleeve is fixedly sleeved around an outer periphery of the inner wheel.

10. The roller-supported multi-piece omnidirectional wheel according to claim 9, wherein an outer surface of the inner wheel is circumferentially provided with positioning ribs, and an inner wall of the outer wheel sleeve is circumferentially provided with engagement slots that engage with the positioning ribs.

11. The roller-supported multi-piece omnidirectional wheel according to claim 1, wherein the rim comprises a left rim and a right rim, which are fixedly connected coaxially.
